(19) United States
(12) Patent Application Publication
(10) Pub. No.: US 2006/0152622 A1
(43) Pub. Date: Jul. 13, 2006

(54) Visual contents in karaoke applications

(76) Inventors: Jek-Thoon Tan, Yew Mei Green (SG); Sheng-Mei Shen, Windemere (SG)

Correspondence Address: LADAS & PARRY, 26 WEST 61ST STREET, NEW YORK, NY, 10023, US

(21) Appl. No.: 10/528,916

(22) PCT Filed: Sep. 25, 2003
(86) PCT No.: PCT/SG03/00231

§ 371 Date: Mar. 23, 2005

(30) Foreign Application Priority Data
Oct. 4, 2002 (SG) 200206070-5

(51) Int. Cl. H04N 7/08; H04N 7/087; H04N 7/084; H04N 5/445; H04N 7/16

(52) U.S. Cl. 348/473; 348/563; 725/135

(57) ABSTRACT

In almost every Karaoke song, there are intervals where the singing is paused and only music is played for some time before the singing continues. The non-singing sections tend to be more substantial at the beginnings and ends of Karaoke songs. During these non-singing intervals, additional information may be displayed onto the Karaoke text region, independent of the background video content. Textual and interactive contents for display outside the Karaoke text region can also be inserted anywhere throughout the Karaoke song. This provides additional advertising space as well as the opportunity to develop interactive digital TV Karaoke. The textual and interactive contents that are inserted for display are encoded as data for more effective transmission, compared with putting them into the video stream. In addition, this invention introduces an option for the content creator to insert relevant textual and interactive contents prior to distribution to media distribution companies or broadcasters. With such an option, the content rights holder may insert desirable advertising messages that shall be displayed to the user regardless of the media distribution companies or broadcasters.

### FIELD OF THE INVENTION

The present invention relates to the introduction of visual content into Karaoke applications, beyond a standard background video or the song text, and in particular it relates to the introduction of such into broadcast Karaoke applications (whether by radio, cable, the internet or otherwise).

### BACKGROUND AND PRIOR ART

In typical Karaoke applications, the Karaoke text is displayed at the bottom of the screen to assist the viewer to sing along with the music or song. The Karaoke text is encoded together with the background video. Such an approach uses up significant transmission bandwidth and is not commercially viable in broadcast applications.

It is known to save transmission bandwidth by transmitting one background video for use with multiple Karaoke songs. In this approach, many Karaoke audio elementary streams and their associated Karaoke text elementary streams containing the text and scrolling information are broadcast at the same time, and each of the songs uses the same video content. As a result, the user has more choices for Karaoke songs without increasing transmission bandwidth significantly. Broadcasters also benefit by inserting advertisements onto the video, as well as by providing value added Karaoke applications to the viewer. However, any such other textual content or advertisements to be displayed are encoded onto the video.

One aspect of Karaoke is that the requirement for singing is not constant throughout a song. There may be a prelude or introduction where no singing is required, significant portions in the middle where no singing is required and a postlude where no singing is required. These are times when the singer is doing nothing and they are recognised as periods in which other things can be done instead.

For instance, according to patent publication JP2001-350482A Karaoke data can include time interval information indicating time bands of non-singing intervals. For a performance, this information is compared with presentation time information relating to a spot programme. The spot programme whose presentation time is closest to the non-singing interval time is displayed during that non-singing interval.

Patent publication JP7-271387 describes a recording medium, which not only records song audio and text information, but also text picture information corresponding to a text picture other than the song text, which is to be displayed. This can be used to avoid a situation in which a singer merely listens to the music and waits for the next step during a musical prelude or interlude.

Japanese patent publication No. JP10-124071 describes a hard disk drive provided with a music data storage part which stores music data on pieces of karaoke music and a music information database which stores information regarding albums containing these pieces of music. In the music data, a flag is provided showing whether or not the music is one contained in an album. A controller determines if a song is one for which the album information is available. During an interval for a song where the information is available, data on the album name and music are displayed as a still picture.

Japanese patent publication No. JP10-268880 describes a system to reduce the memory capacity needed to store respective image data, by displaying still picture data and moving picture data together according to specific reference data. Genre data in the header part of Karaoke music performance data is used to refer to a still image data table to select pieces of still image data to be displayed during the introduction, interlude and postlude of the song. The genre data is also used to refer to a moving image data table to select and display moving image data at times corresponding to text data.

The aim of the present invention is to enable the improved insertion of textual and interactive contents for use in Karaoke applications, for instance during non-singing intervals. Ideally, it is intended to enable a commercially viable scheme that fits digital TV broadcasting standards.

### SUMMARY OF THE INVENTION

According to one aspect of the present invention, there is provided a method of encoding Karaoke applications comprising:
encoding a background video signal for use with one or more Karaoke songs;
encoding one or more Karaoke songs;
encoding Karaoke song texts associated with said one or more songs, to be displayed in a karaoke text display; and
encoding visual contents for display outside the Karaoke text display during playing of said one or more Karaoke songs, as private section data.

According to another aspect of the present invention, there is provided a method of providing audio and video Karaoke signals comprising the steps of:
receiving Karaoke applications encoded according to the above method;
decoding said encoded background video signal;
decoding said encoded one or more Karaoke songs to provide an audio signal;
decoding the encoded one or more Karaoke song texts associated with the one or more decoded songs;
decoding the encoded visual contents; and
combining said background video signal, said one or more Karaoke song texts and said visual contents to form a video signal, with the one or more Karaoke song texts in a karaoke text display and said visual contents in a region outside the karaoke text display during some or all of the one or more songs.

According to a third aspect of the present invention, there is provided apparatus for supplying Karaoke applications comprising:
video encoding means for encoding a background video signal for use with multiple Karaoke songs;
song encoding means for encoding Karaoke songs;
text encoding means for encoding Karaoke song texts associated with said songs, for display in a karaoke text display; and
visual contents encoding means for encoding visual contents for display outside the Karaoke text display during playing of said Karaoke songs, as private section data.

According to again another aspect of the present invention, there is provided apparatus for providing audio and video Karaoke signals comprising:
receiving means for receiving Karaoke applications encoded according to the method of the first aspect or by the apparatus of the third aspect;
video decoding means for decoding the encoded background video signal;
song decoding means for decoding the encoded Karaoke songs to provide an audio signal;
text decoding means for decoding encoded Karaoke song texts associated with said decoded songs;
visual content decoding means for decoding the encoded visual contents; and
combining means for combining said background video signal, said one or more song texts and said visual contents to form a video signal such that the song texts are displayed in a karaoke text display and said visual contents are displayed in a region outside the karaoke text display during some or all of the one or more songs.

According to a further aspect of the present invention, there is provided apparatus for use in editing visual contents for display during Karaoke singing sessions, said apparatus comprising:
means for retrieving a stored karaoke text elementary stream;
means for determining an edit permission status within the retrieved karaoke text elementary stream;
means for editing said visual contents if permitted by the edit permission status; and
means for forwarding the edited visual contents for storage.

With the present invention, visual content can be displayed anywhere, e.g. over the background video, away from the karaoke text, over the area occupied by the karaoke text, but not part of the text display (during non-singing periods) or over both (at different times or simultaneously).

This invention provides additional advertising space as well as the opportunity to develop interactivity in Karaoke applications. It also creates an option for the content creator to insert relevant textual and interactive contents prior to distributing to the media distribution companies or broadcaster. The textual and interactive information is encoded as data for more effective transmission. This invention enables an efficient method of introducing relevant textual and interactive contents in Karaoke application to the user at minimal cost.

### BRIEF DESCRIPTION OF THE DRAWINGS

The present invention will now be further described by way of non-limitative example with reference to the accompanying drawings, in which:

FIG. 1 is a schematic drawing of an embodiment of apparatus for multiplexing textual and interactive contents in a Karaoke application;

FIG. 2 illustrates a Menu Tree Application; and

FIG. 3 illustrates a screen which would appear to a karaoke user, when a signal is provided using the present invention.

### DESCRIPTION

Karaoke content is made up of audio and text and scrolling information for the sing along display, as well as textual and interactive contents in the present invention. The Karaoke songs are encoded by using a relevant digital TV audio encoding standard such as MPEG Layer II or AC-3, and subsequently stored as audio elementary streams. The Karaoke texts and scrolling information, together with additional textual and interactive contents are encoded as Karaoke text elementary streams. Thus, for each Karaoke song, the content creator creates two files, one for an audio elementary stream and the other for a Karaoke text elementary stream. These files are stored in a database and can be distributed to other media distribution companies and broadcasters.

The present invention is exemplified by way of encoding using MPEG-2, although is applicable to other formats.

In encoding for distribution as a transport stream, the Karaoke background content is produced and encoded into a video elementary stream. It can be coded at a lower bit rate, allowing more space for transmitting Karaoke audio songs. A single background video is used for every Karaoke songs to reduce the total transmission bandwidth. The video stream is multiplexed with many Karaoke audio streams and associated private data streams that contain the Karaoke text elementary streams. The Karaoke data comes in the form of private section tables. The contents of the private section tables deliver Karaoke program guides, the Karaoke text and scrolling information associating with the audio, time reference information for synchronizing the scrolling text and audio, as well as the textual and interactive contents and short video clips. The media distribution provider may also edit or insert additional textual and interactive contents embedded in the Karaoke text elementary streams prior transmission.

Encoding of the textual and interactive contents is performed in two stages. In the first stage, the textual and interactive contents are embedded in the Karaoke text elementary stream and subsequently stored in the database. The Karaoke text elementary stream provides sufficient information for the Karaoke decoder in the receiver to display Karaoke text with scrolling colours to signify the singing tempo, as well as the intended textual display relevant to the Karaoke application. The embedded textual content may contain advertising messages or other relevant information. Interactive content such as textual display links or web-links for Internet-TV may also be inserted in this stage. The Karaoke text elementary stream and its associated audio elementary stream can be distributed to other media distribution companies. Since the stage 1 textual and interactive contents are embedded in Karaoke text elementary stream, it provides an option for the content creator to place relevant information intended for decoding before distributing to other media distribution companies.

Prior to broadcast, the media distribution or broadcaster may further edit or add to the textual and interactive contents. Thus, the stage 2 textual and interactive contents are further embedded to form the final Karaoke text elementary stream for decoding in the receiver.

During any non-singing intervals, the Karaoke text region can be designed or constructed to include user information, news flash or advertisements. Throughout the Karaoke application, textual displays can be inserted outside the Karaoke text region and interactivity can be added to provide links relevant to the Karaoke content.

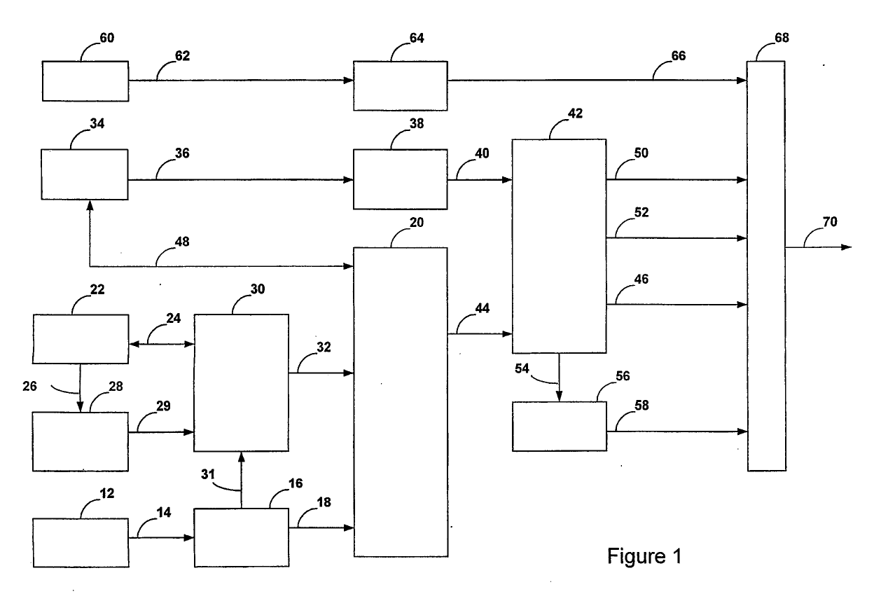

Functional modules for multiplexing textual and interactive contents for use in Karaoke application constructed in accordance with an embodiment of the invention are shown in FIG. 1.

A Karaoke source 12 delivers an audio signal 14 (e.g. music) to an Audio Capture and Encoding module 16, where it is captured and recorded using MPEG Layer II (although other suitable audio compression standards such as AC-3 or the like can be used). One of the outputs of the Audio Capture and Encoding module 16 is the audio elementary stream 18, which is forwarded to and stored in a Karaoke Database 20.

A content creator (e.g. a person) uses a first user editing terminal 22 to create and edit Karaoke text and timing information 24, as well as textual and interactive contents 26.

This first user editing terminal 22 is generally used for songs and scoring scrolling information. A Textual and Interactive Encoding module 28 converts the user input textual and interactive contents 26 to suitable format textual and interactive data 29 for further processing. The output Karaoke text and timing information 24, from the user editing terminal 22, and textual and interactive data 29, from the Textual and Interactive Encoding module 28, are sent to a Karaoke Text Elementary Stream Encoding module 30. These outputs are joined there by another output 31 of the Audio Capture and Encoding module 16. The Karaoke Text Elementary Stream Encoding module 30 is a tool for assisting the content creator. It integrates the input data streams 24, 28 to form the complete Karaoke text elementary stream 32. This too is forwarded to and stored in the Karaoke Database 20.

The Karaoke text elementary stream 32 provides sufficient information for a Karaoke decoder in a receiver to display Karaoke text with scrolling colours to signify the singing tempo associated with the audio elementary stream 18, as well as to generate a textual display over the Karaoke text region during a non-singing period. It also contains information for generating additional textual display outside the Karaoke text region throughout the Karaoke application. The Karaoke text elementary streams 32 and the associated audio elementary streams 18 may be distributed to other media distribution companies or broadcasters for transmission. Since the stage 1 textual and interactive contents are embedded in the Karaoke text elementary stream, it provides an option for the content creator to place relevant content intended for decoding before distributing to other media distribution companies. However, prior to broadcast, the media distribution or broadcaster may further edit or add to the textual and interactive data.

A second user editing terminal 34 is used to edit textual and interactive contents 36, such as graphics and interactive data, including short video clips. The content format for textual and interactive data from the second user editing terminal 34 is the same as from the first user editing terminal 22. This second terminal 34 is normally located on-line and is able to add new content to an existing database (or to replace existing content), whereas the first terminal 22 is used to develop the Karaoke database and is normally located off-line.

For example, Company A (content creation service provider) creates a content “Karaoke_Text_Elementary_Stream” (including the associated audio elementary stream). and stores it in a database using the first user editing terminal 22. Such a stream may be freely distributed for placing advertisement textual information. Alternatively, it could be distributed to a broadcaster or service provider for a fee.

When such stream are broadcast to the consumer, Company B (broadcaster/service provider) may not wish to use this content for a non-text region, that is a region outside where the Karaoke text is displayed and scrolled, but may want to add its own visual data at that point. The broadcaster or service provider may then edit the Karaoke Text Elementary Stream to generate textual content that is different from the original content, using the second user editing terminal 34. However, prior to adding or replacing the relevant content by way of changing a descriptor, the user of the second user editing terminal 34 needs to check the status of a distribution flag in the data. This flag determines whether Company B has the agreement of the content creation provider to make such changes. Company B cannot modify any existing Textual_Presentation_Descriptor() that is “mandated”. However, it can add a new Textual_Presentation_Descriptor() to display a particular content in an unused time interval or display region. Since each Textual_Presentation_Descriptor has its own Distribution_Flag, Company B could mandate the display of this new content.

The user input textual and interactive contents 36 are converted by a Textual and Interactive Encoding module 38 to suitable data format for further processing. The encoded textual and interactive data 40 are then delivered to a Karaoke Application Encoder 42.

The Karaoke Application Encoder module 42 is a tool for assisting the broadcaster to generate the Karaoke application. As well as the encoded textual and interactive data 40, the Karaoke Application Encoder 42 also receives extracted audio elementary and text elementary streams 44 from the Karaoke Database 20. The Karaoke Application Encoder module 42 integrates the encoded textual and interactive data 40 with the extracted Karaoke text elementary streams to generate Karaoke Textual and Interactive Description Tables 46.

Through a connexion to the Karaoke Database 20, a broadcaster can also use the second editing terminal 34 to select a list of Karaoke songs to be broadcast. Control signals 48 extract the selected Karaoke text elementary stream and audio elementary stream files from the Karaoke Database 20, for processing within the Karaoke Application Encoder 42. Subsequently, the Karaoke Application Encoder 42 generates respective program guide tables 50 listing the available Karaoke songs.

Finally, the Karaoke Application Encoder 42 also generates time reference tables 52 (including time reference information for synchronising karaoke scrolling text and audio) based on the various inputs. The Karaoke application encoder 42 runs its own system time clock. This clock is used as a reference when encoding the “Time Reference Table” and the “Karaoke Textual and Interactive Description Table”. The “Time Reference Table” uses the values in the system time clock directly. Any existing clock information in the “Karaoke Textual and Interactive Description Table” is processed to determine the rate of data delivery from this encoder. This clock information is recalculated to synchronize to the system time clock. Prior to delivery, the clock information is updated to be in line with the system time clock, thus enabling synchronization in a subsequent decoding process in a receiver.

The Karaoke Textual and Interactive Description Tables 46, the guide tables 50 and the time reference tables 52 are all private data tables, exemplary formats of which are described later. Private data tables are used as they allow additional data to be transmitted beyond that available in the elementary streams. Private data can also be used as a means for carrying updating software. For example, MPEG-2 specifies packets comprising a PES (packetised elementary stream) and section tables. Each section table is identified by a “table_ID” value. Section tables between values 0x40 and 0xFE are considered as private section tables. Private data fits into the private section tables.

The audio elementary streams 54 from the Karaoke Application Encoder 42 pass through to an Audio PES Encoding module 56, where they are encoded into audio packetized elementary streams (Audio PES) 58. There are multiple audio packetised elementary streams 58, each of which is associated with a Karaoke Textual and Interactive Description Table 46. The Audio PES Encoding module 56 uses the system time clock of the Karaoke Application Encoder 42 when encoding the Audio PES 58.

Thus, all the outputs from the Karaoke Application Encoder 42, together with the Audio PES 58 are in separate streams but are synchronised through clock signals.

In parallel with the audio and text streams mentioned above, in a video section, a video source 60 supplies a Karaoke video signal 62 to a Video PES Encoding module 64, where it is encoded into a video packetized elementary stream (video PES) 66. The video signal 62 forms the Karaoke video background that is used for all the Karaoke songs selection.

The Karaoke Textual and Interactive Description Tables 46, the guide tables 50 and the time reference tables 52 from the Karaoke Application Encoder 42, the audio PES 58 from the Audio PES Encoding module 56 and the video PES 66 from the Video PES Encoding module 64 are all input to a Multiplexing module 68. There they are all multiplexed into a transport stream (TS) 70.

MPEG-2 defines private section tables to carry user or private data. This invention uses the format of private section tables and further defines the semantics of such tables. As private section tables are standard, standard decoders can retrieve the private data. However, the semantics for such a decoder need to be developed to support such implementation. The Guide Tables and the Time Reference Tables can be as defined in Singapore Patent No. 85646.

In a decoder, users can view and select the available Karaoke songs that are being broadcast through the use of program guide tables. As the Karaoke sessions is in progress, the textual and interactive contents are decoded and displayed in the receiver. By using pre-assigned remote control buttons, the user may navigate through the interactive programs that are relevant to the Karaoke application.

An example of the formatting of various information will now be described. In this embodiment, the Karaoke_Text_Elementary_Stream describes the Karaoke text and the scrolling information, as well as the textual and interactive contents. The synchronization timing information for the audio does not reside in the Karaoke_Text_Elementary_Stream. It is embedded in the Karaoke Textual and Interactive Description Table.

The syntax of the Karaoke_Text_Elementary_Stream() is illustrated in Table 1.

TABLE 1

| Syntax | | No. of bits |
|---|---|---|
| Karaoke_Text_Elementary_Stream( ) { | | |
| | ISO_639_Language_Code | 24 |
| | Reserved | 4 |
| | Creation_Information_Data_Length | 12 |
| | For (I=0;I<N;I++){ | |

| | |
|---|---|
| Creation_Information_Data | 8 or 16 |

| | |
|---|---|
| } | |
| Reserved | 6 |
| Simultaneous_Scroll | 1 |
| Reserved | 1 |
| Karaoke_Textual_Data_Length | 16 |
| For (I=0;I<M;I++) { | |

| | |
|---|---|
| Reserved | 6 |
| Singing_Indicator | 2 |
| If (Singing_Indicator==0) { | |

| | |
|---|---|
| Start_Display_Time | 16 |
| ISO_639_Language_Code | 24 |
| Reserved | 2 |
| Row1_Text_Length | 6 |
| For (J=0;J<Row1_Text_Length;J++){ | |

| | |
|---|---|
| Text_Code | 8 or 16 |

| | |
|---|---|
| } | |
| ISO_639_Language_Code | 24 |
| Reserved | 2 |
| Row2_Text_Length | 6 |
| For (J=0;J<Row2_Text_Length;J++){ | |

| | |
|---|---|
| Text_Code | 8 or 16 |

}
For (J=0;J<Row1_Text_Length+1;J++){

| | |
|---|---|
| Time_Code | 16 |

}
For (J=0;J<Row2_Text_Length+1;J++){

| | |
|---|---|
| Time_Code | 16 |

}

}
else {

| | |
|---|---|
| Descriptors_Loop_Length | 16 |
| For (J=0;J<N;J++){ | |

Descriptors( )

}

}

| | |
|---|---|
| } | |
| Descriptors_Loop_Length | 16 |
| For (I=0;I<N;I++){ | |

Descriptors( )

| | |
|---|---|
| } | |
| CRC_32 | 32 |

}

The semantic definitions are:
ISO_{—}639_Language_Code—This 24-bit field contains 3 character ISO 639 language code of the following text fields. Each character is coded into 8 bits according to ISO 8859-1.
Creation_Information_Data_Length—This 12-bit field specifies the length of bytes of the following Creation Information Data description. The content creator may place relevant information in Creation_Infomation_Data.
Creation_Information_Data—The code defining the text character. The number of bytes to represent each text character is determined by ISO_{—}639_Language_Code.
Simultaneous_Scroll—A 1-bit field specifies scrolling on the two text display rows to be done independently or simultaneously. A ‘0’ refers to independently. A ‘1’ refers to scrolling simultaneously for dual language applications.
Karaoke_Textual_Data_Length—This 16-bit field specifies the length of bytes of the following Karaoke Textual Data description.
Singing_Indicator—See Table 2. Textual data for non-singing section has non-zero Singing_Indicator value.
Start_Display_Time—This 16-bit field specifies the time for displaying the two text rows. Each count is 20 msec.
Row1_Text_Length—This 6-bit field specifies the number of text characters in the upper display row.
Text_Code—The code defining the text character. The number of bytes to represent each text character is determined by ISO_{—}639_Language_Code field.
Row2_Text_Length—This 6-bit field specifies the number of text characters in the lower display row.
Time_Code—This 16-bit field specifies the scrolling information of individual text character. Each count is 20 msec.
Descriptor_Loop_Length—This 16-bit field specifies the total length in bytes of the following descriptors.
Descriptors()—See Table 3. Available descriptors are Textual_Presentation_Descriptor and Interactive_Links_Descriptor.
CRC_{—}32—This 32-bit field contains CRC value. It can be used to check the correctness of the data in this section.

The definition of the Singing_Indicator is illustrated in Table 2. Textual data for non-singing section has non-zero Singing_Indicator value. The textual data is described in descriptors.

TABLE 2

| Singing_Indicator | |
|---|---|
| Value | Descriptions |
| 0 | Singing section. |
| 1 | Non singing section at the start of the song. |
| 2 | Non singing section at the end of the song. |
| 3 | Non singing section at the middle of the song. |

Table 3 lists the available descriptors in Karaoke Text Elementary Stream. The tag is an identification value for the descriptor. For each Karaoke song application, the Karaoke Text Elementary Stream may carry multiple Textual Presentation Descriptors but only one Interactive Links Descriptor may be present.

TABLE 3

| | | Karaoke_Textual | Interactive_Textual |
|---|---|---|---|
| Tag Value | Descriptor( ) | Loop | Loop |
| 0xE1 | Textual_Presentation_Descriptor( ) | * | * |
| 0xE2 & | Interactive_Links_Descriptor( ) | | * |
| 0xE3 | | | |

* Available

The syntax of the Textual_Presentation_Descriptor is illustrated in Table 4. The Textual_Presentation_Descriptor describes the textual content that shall be displayed by the decoder. It need not be restricted to text, as such. The word “textual” throughout this document can represent both text and graphics.

TABLE 4

| | No. of |
|---|---|
| Syntax | bits |
| Textual_Presentation_Descriptor( ) { | |

| | |
|---|---|
| Descriptor_Tag | 8 |
| Textual_Presentation_ID | 8 |
| Reserved | 2 |
| Distribution_Flag | 3 |
| Data_Interpretation_Format | 3 |
| Textual_Data_Length | 16 |
| For (I=0;I<Textual_Data_Length;I++){ | |

| | |
|---|---|
| Textual_Data | 8 |

}

}

The semantic definitions of this descriptor are:
Descriptor_Tag—This 8-bit field provides an identification value indicating the Textual Presentation Descriptor. It shall have a value of 0xE1.
Textual_Presentation_ID—This 8-bit field provides a unique identification value for the following Textual Presentation Descriptor data. This value is used to provide links in interactive applications. It shall have a value between 0x10 to 0xFF. A value of 0x00 is reserved for specifying the exit of the interactive application. A value of 0x0F is reserved for specifying no action within the interactive application. A value of 0x01 is used to activate the Actions() task. Values between 0x02 to 0x0E are reserved.
Distribution_Flag—See Table 5.
Data_Intepretation_Format—See Table 6.
Textual_Data_Length—This 16-bit field specifies the length of bytes of the following Textual_Data.

Textual_Data—The format of this 8-bit field data is defined by Data_Intepretation_Format.

TABLE 5
Distribution_Flag Definition

| Distribution_Flag | |
|---|---|
| Value | Descriptions |
| 0 | Free distribution. Existing textual |
| | display and editing optional. |
| 1 | Free distribution. Existing textual |
| | display mandatory. No Editing |
| 2 | Free distribution. Existing textual |
| | display mandatory. Editing optional. |
| 3 | License distribution. Existing textual |
| | display and editing optional. |
| 4 | License distribution. Existing textual |
| | display mandatory. No Editing |
| 5 | License distribution. Existing textual |
| | display mandatory. Editing Optional. |
| 6-7 | Reserved |

When the flag indicates “Existing textual display mandatory. Editing Optional”, it means that the existing display can be added to, but nothing can be removed.

TABLE 6
Data_Intepretation_Format Definition

| Data_Intepretation_Format | |
|---|---|
| Value | Descriptions |
| 0 | Reserved |
| 1 | Karaoke Textual Presentation |
| | Format - Basic Level |
| 2-7 | Reserved. |

In this embodiment, the Karaoke Textual Presentation Formats enable displaying of desired visual content over the Karaoke text region during non-singing intervals of a Karaoke song and/or over other parts of the display at certain parts of or even throughout a song, or even between songs too.

The Basic Level Format is described in detail. It enables displaying of visual content in the form of textual content over the Karaoke text region during non-singing intervals of a Karaoke song. The complexity is kept minimal and the decoding requirements are very similar to normal Karaoke text decoding. Additional functions define the intended display position and the time for display, the foreground colour, the background colour, and flashing display attributes. The Start_Display_Time and Display_Time_Interval specify the intended time for display within the Karaoke application. It enables sequencing of textual display and can be used to deliver narrative description to the viewer. The Karaoke Textual Presentation Format—Basic Level need not be restricted to be use only over the Karaoke Text region. It can be used for other parts of the TV display at both singing and non-singing sections within the Karaoke application. The basic level is a simple text-based description language. Higher levels of the Karaoke Textual Presentation Format may be defined to have more complex features like graphics and other presentation engines.

The syntax of the Karaoke Textual Presentation Format—Basic Level is illustrated in Table 7.

TABLE 7

| | | No. of |
|---|---|---|
| Syntax | | bits |
| Karaoke_Textual_Presentation_Format_Basic_Level( ) { | | |
| | Presentation_Data_Length | 16 |
| | For (I=0;I<M;I++) { | |

| | |
|---|---|
| Start_Display_Time | 16 |
| Display_Time_Interval | 16 |
| Presentation_Display_Clear | 1 |
| Reserved | 3 |
| Display_Data_Length | 12 |
| For (J=0;J<N;J++) { | |

| | |
|---|---|
| Reserved | 2 |
| Display_Location_X | 6 |
| Reserved | 2 |
| Display_Location_Y | 6 |
| Reserved | 2 |
| Display_Feature | 6 |
| ISO_639_Language_Code | 24 |
| Reserved | 2 |
| Text_Control_Data_Length | 6 |
| For (K=0;K<Text_Control_Data_Length;K++){ | |

| | |
|---|---|
| Text_Control_Code | 8 or 16 |

}

}

}

}

The semantic definitions are:
Presentation_Data_Length—This 16-bit field specifies the length of bytes of the following data description.
Start_Display_Time—This 16-bit field specifies the time for displaying the text rows. Each count is 20 msec. A value of 0xFFFF indicates that the display is enable immediately.
Display_Time_Interval—This 16-bit field specifies the time interval for displaying the text rows. Each count is 20 msec. A value of 0xFFFF indicates that the display is enable till the next Presentation_Display_Clear value of ‘1’ is encountered or the Karaoke song application end.
Presentation_Display_Clear—This 1-bit field informs the decoder the clear all previous textual display.
Display_Data_Length—This 12-bit field specifies the length of bytes of the following data description.
Display_Location_X—This 6-bit field specifies the X-axis coordinate for the start of the textual display. A value of 0x3F indicates default Karaoke text display region.
Display_Location_Y—This 6-bit field specifies the Y-axis coordinate for the start of the textual display. A value of 0x3F indicates default Karaoke text display region.
Display_Feature—See Table 8. A 6-bit field specifying the preferred display style.
ISO_{—}639_Language_Code—This 24-bit field contains 3 character ISO 639 language code of the following text fields. Each character is coded into 8 bits according to ISO 8859-1.
Text_Control_Data_Length—This 6-bit field specifies the number of text or control characters in the upper display row.

Text_Control_Code—The code defining the text or control character. The number of bytes to represent each text character is determined by ISO_{—}639_Language_Code field. The control codes for changing the display attributes are tabulated in Table 9.

TABLE 8
Display Feature Definition

| Display_Feature Value | Descriptions |
|---|---|
| 0 | None. |
| 1 | Scroll from Left. |
| 2 | Scroll from Right. |
| 3 | Insert from Left |
| 4 | Insert from Right |
| 5 | Insert from Bottom |
| 6 | Insert from Top |
| 7-63 | Reserved |

TABLE 9
Control Codes for Display Attributes

| Text_Control_Code Value | Descriptions |
|---|---|
| 0x01 | Red |
| 0x02 | Green |
| 0x03 | Yellow |
| 0x04 | Blue |
| 0x05 | Magenta |
| 0x06 | Cyan |
| 0x07 | White |
| 0x08 | Black |
| 0x09 | Transparent |
| 0x10 | Change Background Color |
| 0x11 | Interchange foreground/background Color |
| 0x12 | Flash |

The syntax of the Interactive Links Descriptor is illustrated in Table 10. The Interactive Links Descriptor describes the linkages between the various Textual Presentation Descriptors.

TABLE 10

| | No. of |
|---|---|
| Syntax | bits |
| Interactive_Links_Descriptor( ) { | |

| | |
|---|---|
| Descriptor_Tag | 8 |
| if (Descriptor_Tag==0xE3) { | |

| | |
|---|---|
| Reserved | 3 |
| Karaoke_Text_Description_Table_PID | 13 |

}
else {

| | |
|---|---|
| Node_Loop | 8 |
| For (I=0;I<Node_Loop;I++){ | |

| | |
|---|---|
| Node_Name_Length | 8 |
| Node_Name | var |
| Current_Node_ID | 8 |
| Next_Node_ID | 8 |
| Previous_Node_ID | 8 |
| Ascend_Node_ID | 8 |
| Descend_Node_ID | 8 |
| if (Descend_Node_ID==0x01) { | |

| | |
|---|---|
| Action_Loop_Length | 16 |
| For (J=0;J<N;J++) { | |

Actions( )

}

}

}

}

}

The semantic definitions of this descriptor are:
Descriptor_Tag—This 8-bit field provides an identification value indicating the Interactive Links Descriptor. It shall have a value of 0xE2 or 0xE3.
Karaoke_Text_Description_PID—The PID value transporting the Karaoke Text Description Table that contains the Karaoke Text Elementary Stream. The decoder shall use the Textual Presentation Descriptors and Interactive Links Descriptor in this stream for generating the interactive application.
Node_Loop—Number of node descriptions loops.
Current_Node_ID—Contain the value of the current Textual_Presentation_ID.
Next_Node_ID—Contain the value of the next Textual_Presentation_ID. A value of 0x00 is used for exiting the interactive application. A value of 0x0F indicates no action.
Previous_Node_ID—Contain the value of the previous Textual_Presentation_ID. A value of 0x00 is used for exiting the interactive application. A value of 0x0F indicates no action.
Ascend_Node_ID—Contain the value of the Textual_Presentation_ID for the immediate upper level of a menu tree structure. A value of 0x00 is used for exiting the interactive application. A value of 0x0F indicates no action.
Descend_Node_ID—Contain the value of the Textual_Presentation_ID for the immediate lower level of a menu tree structure. A value of 0x00 is used for exiting the interactive application. A value of 0x0F indicates no action. A value of 0x01 is used to activate the Actions() task.
Action_Loop_Length—This 16-bit field specifies the total length in bytes of the following descriptors.
Actions()—Descriptors describing the task upon user activation.

The Guide Table provides Karaoke programme guide information for the viewer to navigate among Karaoke programmes. The syntax of the private section table for Guide Table is illustrated in Table 11.

TABLE 11

| | | No. of |
|---|---|---|
| Syntax | | bits |
| Karaoke_Current_Guide_Table( ) { | | |
| | Table_ID (user defined: 0x9f) | 8 |
| | Section_Syntax_Indicator | 1 |
| | Private_Indicator | 1 |
| | Reserved | 2 |
| | Private_Section_Length | 12 |
| | Reserved | 2 |
| | Version_Number | 5 |
| | Current_Next_Indicator | 1 |
| | Section_Number | 8 |
| | Last_Section_Number | 8 |
| | Karaoke_Application_Code_ID | 16 |
| | Current_UTC_Time | 40 |
| | Reserved | 4 |
| | Karaoke_stream_info_length | 12 |
| | For (I=0;I<N;I++){ | |

Descriptor( )

| | |
|---|---|
| } | |
| Reserved | 3 |
| KTRT_PID | 13 |
| Number_of_Karaoke_Program | 8 |
| For (I=0;I<Number_of_Current_Karaoke_Program;I++){ | |

| | |
|---|---|
| Start_UTC_Time | 40 |
| Stop_UTC_Time | 40 |
| KFDT_Available | 1 |
| Reserved | 2 |
| KTDT_PID | 13 |
| Reserved | 3 |
| Audio_PID | 13 |
| Reserved | 4 |
| Index_Number_Length | 12 |
| For (J=0;J<Index_Number_Length;J++){ | |

| | |
|---|---|
| Index_Number | 8 |

| | |
|---|---|
| } | |
| ISO_639_Language_Code | 24 |
| Title_Text_Length | 8 |
| For (J=0;J<Title_Text_Length;J++){ | |

| | |
|---|---|
| Title_Text_Code | 8 |

| | |
|---|---|
| } | |
| ISO_639_Language_Code | 24 |
| Singer_Text_Length | 8 |
| For (J=0;J<Singer_Text_Length;J++){ | |

| | |
|---|---|
| Singer_Text_Code | 8 |

| | |
|---|---|
| } | |
| Reserved | 4 |
| ES_info_length | 12 |
| For (J=0;J<N;J++){ | |

Descriptor( );

}

| | |
|---|---|
| } | |
| CRC_32 | 32 |

}

The semantic definitions of the fields in the private section table follow the generic syntax common in ISO/IEC 13818 [1]:
Table_ID—This 8-bit field identifies the private table this section belongs to ISO/IEC 13818 [1] defines specific description from 0x00 to 0x3F. The Digital Video Broadcasting (DVB); Specification for Service Information (SI) in DVB systems (EN 300 468) uses values from 0x40 to 0x7F. User defined value starts from 0x80 to 0xFE. Thus, the Table_ID for this table can range from 0x80 to 0xFE.
Section_Syntax_Indicator—Set to ‘0’ to indicate that the private defined data bytes immediately follow the Private_Section_Length.
Private_Indicator—Not used
Private_Section_Length—This 12-bit field specifies the number of remaining bytes in the section immediately following the Private_Section_Length field up to the end of the section.
Version_Number—A 5-bit field specifying the version number of the section table. The Version_Number shall be increment by 1 when a change in the information carried in the section occurs.
Current_Next_Indicator—Set to ‘1’ indicates that the section is the currently applicable section.
Section_Number—An 8-bit field value gives the section number that is running sequentially.
Last_Section_Number—An 8-bit field specifies the last section number.
CRC_{—}32—This 32-bit field contains CRC value. It can be used to check the correctness of the data in this section.

In this invention, the Karaoke program information is embedded in the Guide Table. The semantic definitions are:
Karaoke_Application_Code_ID—A 16-bit unique identification. Set to 0x5459.
Current_UTC_Time—Local date and time in UTC format.
Karaoke_Stream_Info_Length—This 12-bit field specifies the length of bytes of the following descriptors().
KTRT_PID—The PID value of the Karaoke Time Reference Table.
Number_of_Karaoke_Program—An 8-bit field specifies the number of Karaoke programs running currently.
Start_UTC_Time—Starting Time of the Karaoke program.
Stop_UTC_Time—Ending Time of the Karaoke program.
KFDT_Available—A ‘1’ to indicate presence of Karaoke Font Download Table associated with the following Karaoke Text Description Table.
KTDT_PID—The PID value of the Karaoke Textual and Interactive Description Table.
Audio_PID—The PID value of the Audio Packetized Elementary Stream.
Index_Number_Length—Specifies the length of bytes of the following Index_Number.
Index_Number—Index number of the Karaoke program.
ISO_{—}639_language_code—This 24-bit field contains 3 character ISO 639 language code of the following text fields. Each character is coded into 8 bits according to ISO 8859-1.
Title_Text_Length—This 8-bit field specifies the length of bytes of the following Title_Text_Code.
Title_Text_Code—Text describing the Title of the song.
ISO_{—}639_language_code—This 24-bit field contains 3 character ISO 639 language code of the following text fields. Each character is coded into 8 bits according to ISO 8859-1.
Singer_Text_Length—This 8-bit field specifies the length of bytes of the following Singer_Text_Code.
Singer_Text_Code—Text describing the Singer of the song.
ES_Info_Length—This 12-bit field specifies the length of bytes of the following descriptors().

To enable the receiver to display the Karaoke Text together with the associated song, the timing codes as well as Karaoke text and the scrolling information are carried in the Karaoke Textual and Intercative Description Table (KTDT) in the transport stream. The syntax of the private section tables for Karaoke Textual and Interactive Description Table is illustrated in Table 12

TABLE 12

| | | No. of |
|---|---|---|
| Syntax | | bits |
| Karaoke_Textual_Interactive_Description_Table( ) { | | |
| | Table_ID (user defined: 0x9d) | 8 |
| | Section_Syntax_Indicator | 1 |
| | Private_Indicator | 1 |
| | Reserved | 2 |
| | Private_Section_Length | 12 |
| | Reserved | 2 |
| | Version_Number | 5 |
| | Current_Next_Indicator | 1 |
| | Section_Number | 8 |
| | Last_Section_Number | 8 |
| | Karaoke_Application_Code_ID | 16 |
| | Start_Decoding_Time | 24 |
| | Karaoke_Text_Elementary_Stream( ) | var |
| | CRC_32 | 32 |

}

The semantic definitions are:
Karaoke_Application_Code_ID—A 16-bit unique identification. Set to 0x5459.
Start_Decoding_Time_Reference—A 24-bit timer reference for start of decoding the following Karaoke_Text_Elementary_Data(). Use with Karaoke_Time_Reference carried in Karaoke Time Reference Table (KTRT). Each count is 20 msec.
Karaoke_Text_Elementary_Stream()—The elementary data containing the Karaoke textual and scrolling information.

To synchronise the Karaoke Text display and the associated audio, the Karaoke Time Reference Table (KTRT) is introduced to set or update the Karaoke Text decoder timer with the source timing reference. The syntax of the private section table for Karaoke_Time_Reference_Table is illustrated in Table 13.

TABLE 13

| | No. of |
|---|---|
| Syntax | bits |
| Karaoke_Time_Reference_Table( ){ | |

| | |
|---|---|
| Table_ID (user defined: 0x9c) | 8 |
| Section_Syntax_Indicator | 1 |
| Private_Indicator | 1 |
| Reserved | 2 |
| Private_Section_Length | 12 |
| Karaoke_Application_Code_ID | 16 |
| Karaoke_Time_Reference | 24 |
| CRC_32 | 32 |

}

The semantic definitions are:
Karaoke_Application_Code_ID—A 16-bit unique identification. Set to 0x5459.
Karaoke_Time_Reference—A 24-bit timer reference for the decoder to sync with Karaoke encoding time reference in order to synchronise Karaoke audio and text decoding. Each count is 20 msec. Use with Start_Decoding_Time in Karaoke Text Description Table.

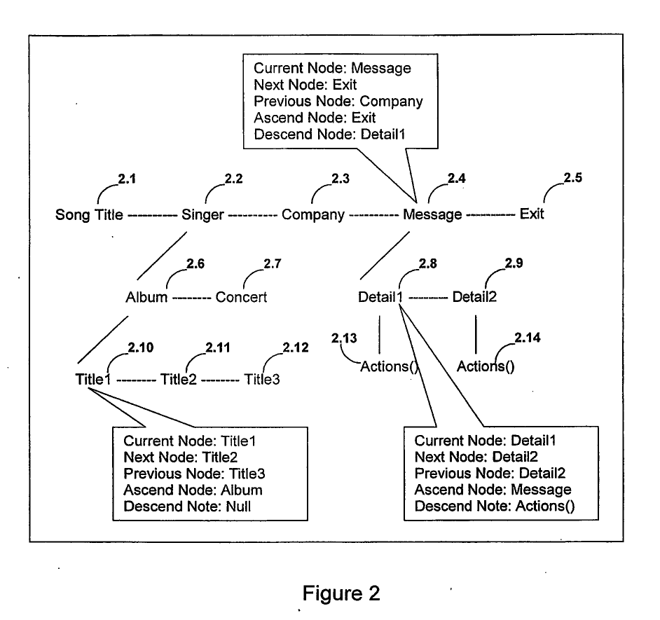

FIG. 2 illustrates an example of an interactive application: a menu tree application relevant to a Karaoke application of the present invention. Three buttons Next, Ascend and Descend (or their equivalent) are needed to navigate throughout the application. The application is started when a user activates the Descend button of the receiver. The textual display for the song title 2.1 is first displayed. The singer information 2.2, the recording company information 2.3 and message 2.4 can be navigated using the Next button. The application exits 2.5 on use of the Next button when the message display 2.4 is currently active. During the singer information 2.2 textual display, the application can descend to the album information 2.6 textual display using the Descend button. The Next and Descend buttons can then be used to navigate through items such as the concert information 2.7 and the titles of the other tracks on the album 2.10, 2.11, 2.12.

“Detail” can be any “Node_Name”. For example, for Concert, the loop data containing “Node_Name”=“Concert” shall be the selected node. Thus, the “Current_Node_ID” in this loop shall be used to look for “Textual_Presentation_Descriptor()” that matches this “Current_Node_ID”. Thus, the textual data whose “Textual_Presentation_ID” matches “Current_Node_ID” shall be displayed. The semantics of Action() have not been defined in this document.

The navigation details within the application are described in the Next_Node_ID, Ascend_Node_ID and Descend_Node_ID in the Interactive Links Descriptor.

This invention provides an effective means of adding further information such as news flash, advertisement or interactive content. In almost every Karaoke songs, there shall be some intervals where the singing is paused and only music is played for sometime before the singing is continue. The non-singing sections also appear quite substantially in starting and ending of Karaoke songs. During this non-singing interval, additional information may be displayed onto the Karaoke text region independent of the background video content. Textual and interactive contents for display outside the Karaoke text region can also be inserted anywhere throughout the Karaoke song. This provides additional advertising space as well as the opportunity to develop interactive digital TV Karaoke. The textual and interactive contents that are inserted for display are encoded as data for more effective transmission compared to putting them onto the video.

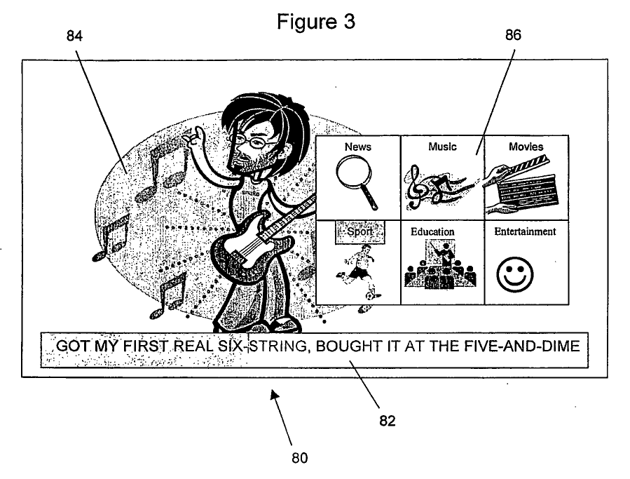

FIG. 3 shows a karaoke display 80 in use. The Karaoke text appears in a display 82 in a karaoke text region near the bottom of the picture. The background video 82 takes up the majority of the display. An interactive display of visual contents 84 also appears in the main part of the display 80, superimposed on the background video.

This invention introduces additional advertising space. It also creates an option for the content creator to insert relevant textual and interactive content prior to distributing to the media distribution companies or broadcasters. With such an option, the content rights holder may insert desirable advertising messages that will be displayed to the user regardless of the media distribution companies or broadcasters. As a result, the content creator may chose to distribute the Karaoke content free and the total cost for delivering the Karaoke content to the user can be reduced. Other scenarios are also possible, not necessarily including advertising or relating solely to advertising.

Whilst the present invention has been described with respect to a specific encoding approach and MPEG-2, other approaches and standards are also clearly applicable. Karaoke in the present invention covers not only songs, where there is a background video, music and a song text, but other similar applications, such as poetry readings or the like, or even where there is no music.

1. A method of encoding Karaoke applications comprising:
encoding a background video signal for use with one or more Karaoke songs;
encoding one or more Karaoke songs;
encoding Karaoke song texts associated with said one or more songs, to be displayed in a karaoke text display; and
encoding visual contents for display outside the Karaoke text display during playing of said one or more Karaoke songs, as private section data.

2. A method according to claim 1, wherein said visual contents are encoded for display at least during non-singing periods of said songs.

3. A method according to claim 2, wherein said visual contents are encoded for display over area in which the song text display is displayed during said non-singing periods.

4. A method according to claim 1, wherein said visual contents are encoded for display over an area outside the area in which the song text display is displayed at any time or throughout a song.

5. A method according to claim 1, wherein the Karaoke song texts are encoded as pre-defined text code.

6. A method according to claim 1, wherein said song texts are encoded into said private section data.

7. A method according to claim 1, wherein scrolling information associated with said songs are encoded with said song texts.

8. A method according to claim 7, wherein display interval information and said scrolling information for singing tempo are encoded as time codes.

9. A method according to claim 1, wherein said song texts are encoded in a song text display.

10. A method according to claim 1, wherein said visual contents are relevant to said songs.

11. A method according to claim 1, wherein said visual contents comprise textual contents.

12. A method according to claim 1, wherein said visual contents comprise programme guide information.

13. A method according to claim 1, wherein said visual contents comprise interactive contents.

14. A method according to claim 13, further comprising:
defining nodal descriptions for said interactive contents for generating visual displays arranged in menu tree structures; and
specifying actions that can be activated by the user by said displayed interactive contents.

15. A method according to claim 1, further comprising defining text-base descriptions of said visual contents and integrating said text-base descriptions into said private section data.

16. A method according to claim 15, further comprising specifying display attributes of said text-base descriptions and integrating said display attributes into said private section data.

17. A method according to claim 15, further comprising specifying the time intervals for display of said text-base descriptions and integrating said time intervals into said private section data.

18. A method according to claim 15, further comprising specifying the sequence and timing for display of said text-base description and integrating said sequence and timing for display into said private section data.

19. A method according to claim 1, wherein the step of encoding visual contents further comprises specifying display positions of said visual contents and integrating said display positions into said private section data.

20. A method according to claim 1, wherein the step of encoding visual contents further comprises setting an edit status, which determines whether the visual contents may be edited.

21. A method according to claim 20, wherein the edit status is set by a first status of user and is applicable to a second status of user.

22. A method according to claim 20, wherein the edit status is set with a flag.

23. A method according to claim 1, wherein the step of encoding visual contents further comprises setting a display status, which determines whether some or all of the visual contents can be prevented from being displayed during playback.

24. A method according to claim 23, wherein the display status is set with a flag.

25. A method according to claim 1, wherein the step of encoding visual contents further comprises setting a distribution status, which determines whether the encoded application or at least part thereof is for licensed distribution.

26. A method according to claim 25, wherein the distribution status is set with a flag.

27. A method according to claim 22, wherein the edit status, display status and distribution status are set by the same flag.

28. A method according to claim 1, further comprising the step of storing the encoded visual contents.

29. A method according to claim 28, wherein the edit status is set by a first status of user and is applicable to a second status of user, further comprising the steps of:
retrieving stored encoded visual contents;
editing the retrieved visual contents if allowed by the edit status; and
encoding the edited visual contents as private section data;
wherein at least the editing step is conducted by a user of said second status.

30. A method according to claim 1, wherein said background video signal is encoded to form a video elementary stream and said one or more Karaoke songs are encoded to form audio elementary streams.

31. A method according to claim 30, further comprising multiplexing said video elementary stream, said audio elementary streams and said private section data in a transport stream for broadcast.

32. A method according to claim 1, further comprising the step of broadcasting said encoded applications.

33. A method according to claim 32, when the broadcasting step comprises broadcasting the encoded applications as a television signal.

34. A method of providing audio and video Karaoke signals comprising the steps of:
receiving Karaoke applications encoded according to claim 1;
decoding said encoded background video signal;
decoding said encoded one or more Karaoke songs to provide an audio signal;
decoding the encoded one or more Karaoke song texts associated with the one or more decoded songs;
decoding the encoded visual contents; and
combining said background video signal, said one or more Karaoke song texts and said visual contents to form a video signal, with the one or more Karaoke song texts in a karaoke text display and said visual contents outside the karaoke text display during some or all of the one or more songs.

35. Apparatus for supplying Karaoke applications comprising:
video encoding means for encoding a background video signal for use with multiple Karaoke songs;
song encoding means for encoding Karaoke songs;
text encoding means for encoding Karaoke song texts associated with said songs, for display in a karaoke text display; and
visual contents encoding means for encoding visual contents for display outside the Karaoke text display during playing of said Karaoke songs, as private section data.

36. Apparatus according to claim 35, wherein said text encoding means is further operable to encode scrolling information associated with said songs with said text displays.

37. Apparatus according to claim 35, wherein said text encoding means is operable to encode said song texts into said private section data.

38. Apparatus according to claim 35, wherein said visual contents comprise textual content.

39. Apparatus according to claim 35, wherein said visual contents comprise interactive contents.

40. Apparatus according to claim 39, further comprising nodal description defining means for defining nodal descriptions for said interactive contents for generating visual displays arranged in menu tree structures.

41. Apparatus according to claim 35, further comprising edit status setting means for setting an edit status, which determines whether the visual contents may be edited.

42. Apparatus according to claim 41, wherein the edit status setting means is operable by a first status of user for setting an edit status applicable to a second status of user.

43. Apparatus according to claim 41, wherein the edit status is set with a flag.

44. Apparatus according to claim 35, further comprising display status setting means for setting a display status, which determines whether some or all of the visual contents can be prevented from being displayed during playback.

45. Apparatus according to claim 44, wherein the display status is set with a flag.

46. Apparatus according to claim 35, further comprising distribution status setting means for setting a distribution status, which determines whether the encoded application or at least part thereof is for licensed distribution.

47. Apparatus according to claim 46, wherein the distribution status is set with a flag.

48. Apparatus according to claim 43, wherein the edit status, display status and distribution status are set by the same flag.

49. Apparatus according to claim 35, further comprising storing means for storing the encoded visual contents.

50. Apparatus according to claim 49, wherein the edit status setting means is operable by a first status of user for setting an edit status applicable to a second status of user further comprising editing means for use by a user of said second status, for retrieving stored encoded visual contents, editing the retrieved visual contents if allowed by the edit status, and encoding the edited visual contents as private section data.

51. Apparatus according to claim 35, further comprising multiplexing means for multiplexing the encoded background video signal, the encoded karaoke songs, the encoded karaoke song texts and the encoded visual contents into a transport stream for broadcast.

52. Apparatus according to claim 35, operable according to the method of encoding Karaoke applications comprising:
encoding a background video signal for use with one or more Karaoke songs;
encoding one or more Karaoke songs;
encoding Karaoke song texts associated with said one or more songs, to be displayed in a karaoke text display; and
encoding visual contents for display outside the Karaoke text display during playing of said one or more Karaoke songs, as private section data.

53. Apparatus for providing audio and video Karaoke signals comprising:
receiving means for receiving Karaoke applications encoded according to the method of claim 1;
video decoding means for decoding the encoded background video signal;
song decoding means for decoding the encoded Karaoke songs to provide an audio signal;
text decoding means for decoding encoded Karaoke song texts associated with said decoded songs;
visual content decoding means for decoding the encoded visual contents; and
combining means for combining said background video signal, said one or more song texts and said visual contents to form a video signal such that the song texts are displayed in a karaoke text display and said visual contents are displayed in a region outside the karaoke text display during some or all of the one or more songs.

54. Apparatus for use in editing visual contents for display during Karaoke singing sessions, said apparatus comprising:
means for retrieving a stored karaoke text elementary stream;
means for determining an edit permission status within the retrieved karaoke text elementary stream;
means for editing said visual contents if permitted by the edit permission status to provide new visual content;
means for forwarding the edited visual contents for storage; and means for setting the edit permission status of the newly provided visual content.

55. A method of encoding Karaoke applications or the like, comprising:
encoding a background video signal for use with one or more Karaoke songs;
encoding texts to be displayed in a karaoke text display; and
encoding visual contents for display outside the Karaoke text display, as private section data.
